(19) United States
(12) Patent Application Publication
(10) Pub. No.: US 2026/0028976 A1
(43) Pub. Date: Jan. 29, 2026

(54) METHOD FOR OPERATING A FLUID CONVEYING DEVICE, FLUID CONVEYING DEVICE, COMPUTER PROGRAM, AND COMPUTER-READABLE MEDIUM

(71) Applicant: Vitesco Technologies GmbH, Regensburg (DE)

(72) Inventors: Marius-Dorel FATU, Timisoara (RO); Thomas SCHÖN, Parsberg (DE)

(21) Appl. No.: 18/848,206

(22) PCT Filed: Mar. 28, 2023
(86) PCT No.: PCT/EP2023/057910

§ 371 Date: Mar. 21, 2025

(30) Foreign Application Priority Data
Mar. 31, 2022 (EP) 22465524.1
Apr. 26, 2022 (DE) 10 2022 204 008.2

(51) Int. Cl. F04B 43/04; H02K 7/14

(52) U.S. Cl. CPC F04B 43/04; H02K 7/14

(57) ABSTRACT

A fluid conveying device and a method for operating a fluid conveying device, the fluid conveying device having an electric motor which for driving a pump stage is operatively connected to the latter, the method includes: a) rotating-speed-dependent controlling of the electric motor when the actual speed of the electric motor corresponds to at least one threshold value, b) step-by-step operation of the electric motor when the actual speed of the electric motor corresponds to a value below the threshold value.

### CROSS REFERENCE TO RELATED APPLICATIONS

This is a U.S. national stage of Application No. PCT/EP2023/057910 filed Mar. 28, 2023. Priority is claimed on European Application No. EP 22465524.1 filed Mar. 31, 2022 and German Application No. DE 10 2022 204 008.2 filed Apr. 26, 2022, the contents of which are incorporated herein by reference.

### BACKGROUND OF THE INVENTION

### 1. Field of the Invention

The disclosure relates to a method for operating a fluid conveying device, a fluid conveying device, a computer program, and a computer-readable medium.

### 2. Description of the Related art

Publication US 2002/0043253 A1 discloses a fuel-conveying device of which the electric motor is operated as a function of pressure.

### SUMMARY OF THE INVENTION

An object of the present invention lies in achieving a method that overcomes the disadvantages of the methods from the prior art, or at least represents an alternative method to the methods from the prior art. An object furthermore lies in providing a fluid conveying device by way of which the method steps of the method according to one aspect of the invention can be carried out. A further object furthermore lies in providing a computer program that comprises commands that cause the fluid conveying device to carry out the method steps of the method according to one aspect of the invention. Moreover, a further object lies in providing a computer-readable medium on which the computer program according to one aspect of the invention is stored.

An exemplary aspect of the invention relates to a method for operating a fluid conveying device, the fluid conveying device having an electric motor which for driving a pump stage is operatively connected to the latter. The method comprises:
rotating-speed-dependent controlling of the electric motor when the actual speed of the electric motor corresponds to at least one threshold value,
step-by-step operation of the electric motor when the actual speed of the electric motor corresponds to a value below the threshold value.

The method according to one aspect of the invention enables a fluid conveying device to be able to be operated even at speeds that lie below the threshold value. As a result thereof, it is possible by a fluid conveying device to provide to a fluid consumer, for example an internal combustion engine or a system for the exhaust gas post-treatment, small, conveyed quantities of the fluid to be conveyed.

In other words, the threshold value corresponds to a limit rotating speed below which the electric motor is operated step-by-step, thus like a stepper motor. When the rotating speed of the electric motor corresponds to the limit rotating speed or is above the latter, the electric motor is controlled so as to depend on the rotating speed.

It is particularly expedient for the electric motor to be configured as a permanently excited synchronous machine. Independently thereof, it is advantageous for the electric motor to have a rotor. The electric motor is preferably configured as an external rotor or as an internal rotor.

In general, in the context of the disclosure of this publication the rotating speed of the electric motor, or the speed of the electric motor, means the rotating speed of the rotor of the electric motor, for example in revolutions per unit of time. Accordingly, the actual speed of the electric motor means the current speed of the electric motor, thus the current rotating speed of the rotor of the electric motor. The position of the electric motor means in particular the angular position of the rotor of the electric motor, preferably in relation to the stator of the electric motor.

The determination of the rotating speed of the electric motor preferably takes place by at least one position sensor, preferably by three position sensors. The position sensor is or the position sensors are preferably configured so as to be sensitive to a magnetic field and can thus detect the position, in particular the angular position, the angular travel, the speed, in particular the rotating speed, the revolutions, and/or the angular speed of the electric motor, thus of the rotor of the electric motor. It is particularly expedient for the magnetic field that interacts with the position sensor to be generated by a dedicated permanent magnet which for driving the rotor is operatively connected to the latter. As a far more cost-effective alternative thereto, permanent magnets of the rotor of the permanently excited synchronous machine are utilized to this end. Advantageously, the three position sensors are arranged in the circumferential direction of the rotor of the electric motor, preferably at a distance of 120° from each other with respect to the axis of rotation of the rotor.

It is particularly advantageous for the at least one position sensor to be a Hall sensor. A plurality of, preferably three, Hall sensors of this type are advantageously disposed in the circumferential direction of the rotor of the electric motor. It is particularly advantageous for the position sensor or the position sensors, in particular the Hall sensors, to be closed in a fluid tight manner by plastics material or a casting compound. This contributes to the robustness and to a long service life as well as to the functional reliability of the sensors.

It is particularly expedient for the pump stage to be a displacement pump stage. Displacement pump stages have the advantage that they can be operated in two opposite directions. In other words, it is conceivable that the method according to the invention comprises reversing the conveying direction. For example, a gerotor pump stage, a rotary vane pump stage, or a gear pump stage is conceivable. Moreover, it is conceivable to provide a diaphragm pump or a diaphragm pump stage as the pump stage.

In general, in the context of the disclosure of this publication a fluid conveying device means in particular a water conveying device for an internal combustion engine and/or for a motor vehicle having an internal combustion engine. Alternatively thereto, a fluid conveying device is conceivably an SCR conveying device for the exhaust gas posttreatment of exhaust gases of an internal combustion engine. The fluid which is conveyed by the fluid conveying device is therefore a liquid, in particular water or a urea solution. The urea solution is conveyed to an exhaust gas post-treatment system by the SCR conveying device and/or the method. The water is conveyed to a water injection system by the water conveying device, and by the water injection system made available to the combustion process of the internal combustion engine.

A further preferred exemplary aspect is characterized in that a revolution of the electric motor, in particular a revolution of the rotor of the electric motor, is subdivided into at least two steps. Depending on the number of pole pairs and/or the stator winding, far more steps for subdividing a revolution of the electric motor are conceivable. For example, four, six, eight, ten, twelve, 14 or 16 steps or more per revolution of the electric motor, in particular per complete revolution of the electric motor, are thus conceivable. The steps are expediently of identical size, i.e. have an angular travel of identical size.

The steps of the electric motor are forced with the aid of voltage vectors, which comprise a control current. The value of the electric current of the voltage vectors, thus the control current, here is chosen in such a manner that it is ensured that the rotor within a determined or predetermined period of time moves to a nominal position until the actual position of the rotor corresponds to the nominal position. A step is thus completed, whereupon the voltage vector can be deactivated and a further voltage vector which in terms of the angular position thereof differs from the previous voltage vector can be activated, as a result of which a new nominal position is predefined. A new step of the rotor is initiated as a result. The steps of the rotor are able to be monitored, verified and/or counted by the position sensor, the position sensors or the Hall sensors.

A revolution of the electric motor is in particular to be understood to be a revolution of the rotor of the electric motor. The one revolution of the electric motor or of the rotor of the electric motor is preferably a complete revolution. In other words, a revolution of this type advantageously corresponds to a rotation of the rotor of 360° about the rotation axis thereof.

A further preferred exemplary aspect is characterized in that the method further comprises counting of the steps, in particular the individual steps. A separate counter can be provided to this end. Alternatively thereto, a counter of this type integrated in a control apparatus is conceivable, the latter being a component part of the fluid conveying device or of the electric motor. Alternatively thereto, it is possible for the control apparatus to be configured and/or disposed separately from the fluid conveying device and/or separately from the electric motor. In the case of displacement pump stages, one step is sufficiently proportional to the conveyed quantity of fluid, as a result of which the entire conveyed quantity of fluid during a temporal period can be detected by the counting of the steps. There also exists a correlation between the step count and the fluid pressure. The steps of the rotor are able to be monitored, verified and/or counted by the position sensor, the position sensors or the Hall sensors, said sensors interacting in particular with the counter.

A further preferred exemplary aspect is characterized in that the counting of the individual steps takes place during the rotating-speed dependent-controlling of the electric motor, in that the counting takes place during the step-by-step operation, or in that the counting of the individual steps takes place during the rotating-speed-dependent controlling of the electric motor as well as during the step-by-step operation of the electric motor. A transition from the rotating-speed-controlled operation of the electric motor to the step-by-step operation of the electric motor is able to be performed in a simple, interference-free and seamless manner in particular when the counting of the individual steps takes place during the rotating-speed-dependent controlling of the electric motor as well as the step-by-step operation of the electric motor. Moreover, the entire conveyed quantity of the fluid determined during the operation of the fluid conveying device can be determined from the total step count.

It is particularly expedient for the counting of the steps to be performed by the position sensor or the position sensors or the Hall sensors.

A further preferred exemplary aspect is characterized in that a nominal speed of the electric motor is determined by a nominal pressure and/or a nominal conveying volume of the fluid conveying device, and/or in that a nominal step count or nominal position of the electric motor is determined by a nominal pressure and/or a nominal conveying volume of the fluid conveying device. Alternatively or additionally to the nominal conveying volume, this can be a nominal conveying volume flow. It is furthermore conceivable that the nominal speed of the electric motor is additionally determined by an actual pressure and/or by an actual conveying volume or conveying volume flow, respectively. It is moreover conceivable that the nominal step count of the electric motor is additionally determined by an actual pressure and/or by an actual conveying volume or conveying volume flow, respectively. The nominal speed of the electric motor or the nominal step count or the nominal position is predefined with the aid of the nominal pressure, which is predefined by an internal combustion engine for example, and an actual pressure, which is determined by a pressure sensor. Nominal pressure, actual pressure, nominal conveying volume, actual conveying volume, nominal conveying volume flow and nominal conveying volume flow relate in each case to the fluid of the fluid conveying device which is to be conveyed, is able to be conveyed, or is conveyed, in particular at the fluid output of the fluid conveying device, thus on the pressure side where the pressure sensor is preferably situated.

A further preferred exemplary aspect is characterized in that the step-by-step operation is a closed-loop control of the electric motor, in other words a control method of the electric motor. In other words, it is preferable for the step-by-step operation not to be a closed-loop control of the electric motor. Put differently, the electric motor is operated in such a manner that the rotor position is forced step-by-step with the aid of voltage vectors which comprise a control current. The value of the electric current of the voltage vectors, thus the control current, here is chosen in such a manner that it is ensured that the rotor within a determined or predetermined period of time moves or at least should move to a nominal position, until the actual position corresponds to the nominal position. Thereafter, the voltage vector is deactivated and a further voltage vector which in terms of the angular position thereof differs from the previous voltage vector is activated, as a result of which a new nominal position is predefined. Thereafter, the rotor moves from its previous nominal position to the new nominal position. This angular travel from the previous nominal position to the new nominal position corresponds to a step or a step length. In particular when the rotor is to carry out a plurality of steps, a plurality of voltage vectors of dissimilar angular positions succeed one another in a temporally offset manner. As a result thereof, the rotor is moved temporally successively to the nominal position associated with the respective voltage vector until the rotor has assumed a terminal nominal position which is predefined by the temporally last voltage vector. Each voltage vector, in particular the orientation of the latter, thus the angular position of the voltage vector in relation to the stator, predefines the position of the rotor after one step. In general, the voltage vectors are generated by the stator winding of the electric motor.

A further preferred exemplary embodiment is characterized in that the rotating-speed-dependent controlling of the electric motor comprises positively or negatively accelerating the electric motor until the actual speed of the electric motor corresponds to the nominal speed of the electric motor, and/or in that the step-by-step operation or the closed-loop control of the electric motor comprises a number of steps after which the electric motor assumes a terminal nominal position and/or has reached a nominal step count. As a result, the required pressure, the required conveying volume or the required conveying volume flow is made available to the corresponding fluid consumer.

A further preferred exemplary embodiment is characterized in that the electric motor is stopped when no fluid conveying is required. The stoppage of the electric motor in particular means the stoppage of the rotor of the electric motor. Stoppage is in particular to be understood such that the rotor does not carry out any rotation that causes conveying of fluid. Electric power is saved as a result, on the one hand, and it is ensured as a result, on the other hand, that the entire quantity of fluid conveyed during the operation of the method, during the operation of the fluid conveying device, during the operation of the fluid consumer or during a specific time period is able to be determined, or is determined, respectively, from the counting of the steps, which is proportional to the quantity of conveyed fluid. This enables a conclusion to be drawn, for example, as to whether a fluid tank, thus for example a water tank or a urea tank, has to be topped up.

A further preferred exemplary aspect is characterized in that the position of the stopped electric motor is maintained until fluid conveying is required and the electric motor as a result thereof reassumes operation. It is prevented as a result thereof that more fluid than necessary is conveyed. Furthermore, the determination of the entire quantity of conveyed fluid from the counting of the steps becomes able to be more accurately determined as a result.

Fluid conveying is in principle requested by a control apparatus of an internal combustion engine. A nominal pressure or a nominal conveying volume (flow) is requested here and compared with an actual pressure or an actual conveying volume (flow), respectively. As a function of the comparison, the speed of the electric motor is correspondingly increased when the nominal value is above the actual value, or decreased when the nominal value is below the actual value.

A further preferred exemplary aspect is characterized in that the counting of the steps continues beyond the stoppage of the electric motor. In other words, the counting of the steps is not ended as a result of the stoppage. As a result, it is possible to carry out the counting of the steps during the entire operation, even when no fluid conveying should take place in the intervening time. As a result, the entire quantity of fluid conveyed during the operation of the fluid conveying device can be established.

A further preferred exemplary aspect is characterized in that the method during the step-by-step operation or the closed-loop control has an error compensation which comprises:
determining a positional difference between the actual position and the nominal position of the electric motor during a revolution of the electric motor,-adapting a control current as a function of the previously determined positional difference. An error compensation of this type is necessary in particular in the case of diaphragm pump stages by virtue of the temperature-dependent elasticity of the latter. It can thus typically arise that the steps of the electric motor are performed too fast or too slowly, or that the number of steps of the electric motor undershoots or overshoots the nominal step count. As a result of these deviations, an excessive or insufficient pressure of the fluid is provided, this leading to insufficient or excessive fluid being conveyed. Adapting the control current means that the control current is reduced should the electric motor perform the steps too fast or the number of steps of the electric motor overshoot the nominal step count. Alternatively thereto, it is possible that the control current is increased should the electric motor perform the steps too slowly or the number of steps of the electric motor undershoot this nominal step count.

In general, the nominal position of the electric motor after one step is predefined by a voltage vector, while the actual position of the electric motor is established by one or a plurality of position sensors. As a result, it can be established whether the electric motor performs the steps too fast or the number of steps of the electric motor overshoots the nominal step count. As a result, it can also be established whether the electric motor performs the steps too slowly or the number of steps of the electric motor undershoots this nominal step count. The adaptation of the control current for the error compensation can be performed thereafter.

The error compensation is preferably performed in each revolution of the electric motor.

A further preferred exemplary aspect is characterized in that the position of the electric motor in relation to each positional difference is detected, and the adapted control current is used as a function of this position. The positional difference is in particular determined after the individual steps of the electric motor. The adapted control current can be used precisely in the position of the electric motor where the positional difference arose in the preceding revolution, for example. Alternatively thereto, the control current can also be used one, two, three or four steps before the position of the electric motor where the positional difference arose in the preceding revolution. As a result, a uniform rotation of the electric motor, this meaning the rotation of the rotor of the electric motor, is achieved, by way of which an ideally precise nominal pressure is achieved.

It is expedient for the positional difference to be determined by the position sensor, the position sensors or the Hall sensors. In other words, the actual position determined by the position sensors is compared with the nominal position predefined by the voltage vectors, and the positional difference is thus determined.

Alternatively to all preceding and subsequent embodiments, it is conceivable that the stepwise operation is alternatively a control of the electric motor instead of a regulation of the electric motor.

Alternatively to all preceding and subsequent embodiments, it is conceivable that the electric motor is operated or accelerated, in particular operated stepwise, in the conveying direction and in the opposite direction to the conveying direction in order to achieve the desired conveying volume. The object in terms of the fluid conveying device is achieved in that a fluid conveying device having an electric motor which for driving a pump stage is operatively connected to the latter, a control unit for operating the electric motor, at least one position sensor, and components that are suitable for carrying out the method according to the invention is provided.

It is also preferable for the fluid conveying device to be configured as a water conveying device for an internal combustion engine and/or for a motor vehicle having an internal combustion engine. In such a case, the water conveying device supplies the internal combustion engine with water, which by components of a water injection system is supplied to the combustion process of the internal combustion engine.

Alternatively thereto, it is conceivable that the fluid conveying device is configured as an SCR conveying device for the exhaust gas post-treatment of exhaust gases of an internal combustion engine. In such a case, the SCR conveying device supplies an exhaust gas post-treatment system with a urea solution.

It is particularly expedient for the electric motor to be configured as a permanently excited synchronous machine. Independently thereof, it is advantageous for the electric motor to have a rotor. The electric motor is preferably configured as an external rotor or as an internal rotor.

It is particularly advantageous for the at least one position sensor to be a Hall sensor or the position sensors to be a Hall sensors. A plurality of, preferably three, Hall sensors of this type are advantageously disposed in the circumferential direction of the rotor of the electric motor. It is particularly advantageous for the position sensor, in particular the Hall sensors, to be closed in a fluid tight manner by plastics material or a casting compound. This contributes to the robustness and to a long service life as well as to the functional reliability of the sensors.

It is particularly expedient for the pump stage to be a displacement pump stage. Displacement pump stages have the advantage that they can be operated in two opposite directions. In other words, it is conceivable that the method according to the invention comprises a method step that reverses the conveying direction. For example, a gerotor pump stage, a rotary vane pump stage, or a gear pump stage is conceivable. Moreover, it is conceivable to provide a diaphragm pump or a diaphragm pump stage as the pump stage.

The object in terms of the computer program is achieved in that a computer program which comprises commands that cause the fluid conveying device according to the invention to carry out the method steps of the method according to the invention is provided. A computer program of this type enables the method according to the invention to be easily applied to an existing fluid conveying device.

The object in terms of the computer-readable medium is achieved in that a computer-readable medium on which the computer program according to the invention is stored is provided. The computer-readable medium is preferably a rewritable memory, this ensuring that future revisions of the method can be implemented. Alternatively thereto, this is preferably a non-rewritable memory, this ensuring a safeguard against manipulation.

Advantageous developments of the present invention are described in the dependent claims and in the following description of the figures.

### BRIEF DESCRIPTION OF THE DRAWINGS

The invention will be explained in more detail hereunder by exemplary embodiments with reference to the drawings. In the drawings:

FIG. 1 is a motor vehicle having the fluid conveying device according to the invention; and

FIG. 2 is a flowchart of the method according to the invention.

### DETAILED DESCRIPTION OF THE PRESENTLY PREFERRED EMBODIMENTS

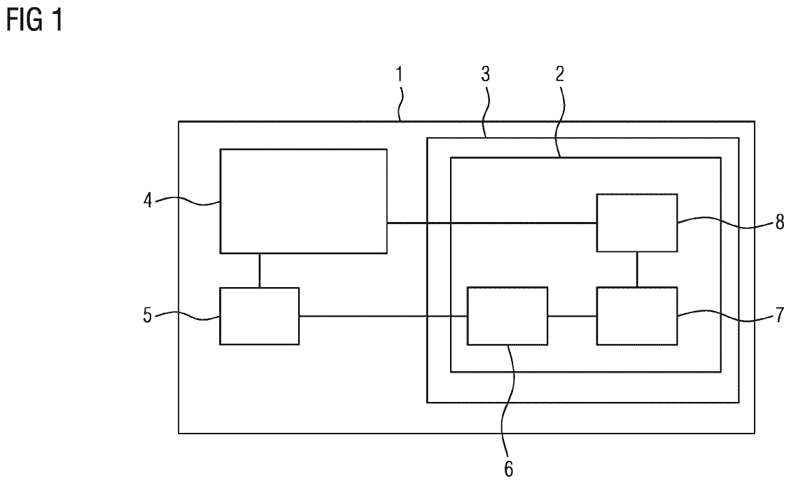

FIG. 1 shows a motor vehicle 1 having an internal combustion engine 4 and a control apparatus 5 for the internal combustion engine 4. A urea solution for the exhaust gas post-treatment is conveyed to an exhaust gas post-treatment system of the internal combustion engine 4 by a fluid conveying device 2, which is capable of carrying out the method according to the invention, is configured as an SCR conveying device for the exhaust gas post-treatment and is disposed within a fluid tank 3 in which the urea solution is situated. The fluid conveying device 2 comprises a control apparatus 6 for the fluid conveying device 2, wherein the control apparatus 6 is capable of operating an electric motor 7 and thus the fluid conveying device 2 by the method according to the invention, wherein the electric motor 7 is configured as a permanently excited synchronous machine and drives a diaphragm pump stage 8, which conveys the urea solution from the fluid tank 3 to the exhaust gas line of the internal combustion engine 4. A computer program which comprises the method steps of the method according to the invention is stored on the control apparatus 6 for the fluid conveying device 2. Moreover, the electric motor 7 comprises three Hall sensors which are disposed so as to be distributed in the circumferential direction of the rotor and detect the position of the rotor of the electric motor 7.

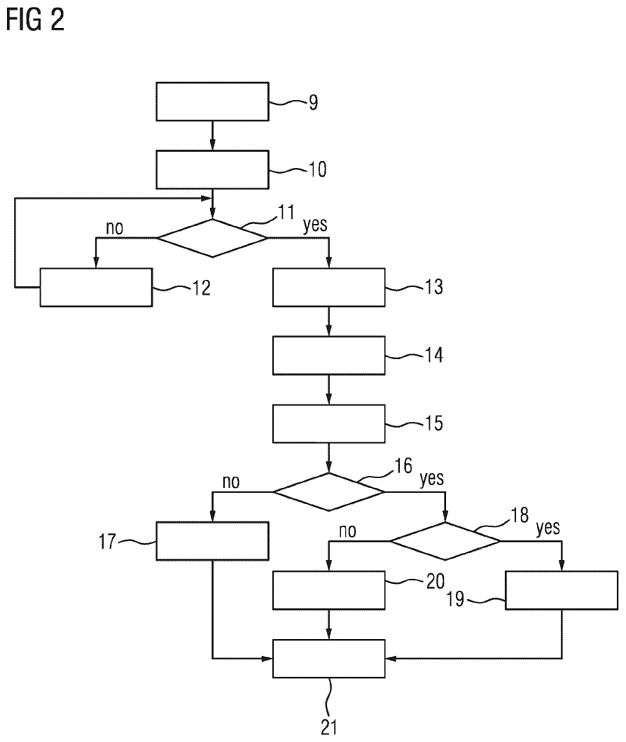

FIG. 2 shows a flowchart of the method according to the invention. The first method step 9 comprises starting the method, while the second method step 10 comprises determining the actual speed of the electric motor. The three Hall sensors are used for determining the actual speed, for example. In the third method step 11, the determined actual speed of the electric motor is compared with a threshold value. If the actual speed corresponds to at least the threshold value, the electric motor of the fluid conveying device is thus operated by controlling the rotating speed, this representing the fourth method step 12. Should the actual speed of the electric motor correspond to a value of a speed below the threshold value, the electric motor is operated, thus controlled, step-by-step, this representing the fifth method step 13. In the sixth method step 14 a nominal step count is established as a function of the requested nominal pressure, the latter being predefined by a control apparatus of an internal combustion engine, for example, while the steps are carried out as rotating movements of the rotor of the electric motor in the seventh method step 15. In the eighth method step 16, it is verified whether the rotor of the electric motor has been started from stationary or there was any pre-existing rotation. Should there not have been any previous rotation, no further action is taken and the electric motor continues to be operated in a controlled manner, this representing the ninth method step 17. Should there have been any preexisting rotation of the rotor of the electric motor, it is verified whether the previous rotation was within specific error margins, this representing the tenth method step 18. For example, an error exists when fewer steps have been carried out than required by the nominal step count. Whether a deviation of this type exists can be determined by the Hall sensors which are utilized for counting the steps. This is followed by the twelfth method step 20, if the previous rotation of the rotor of the electric motor was within the predetermined limits, which means that the same control current values are used in the same rotor positions for the next step-by-step rotation. Should the previous rotation of the rotor of the electric motor have been outside the predetermined limits, the control current values for the next rotation of the rotor are correspondingly adapted, thus increased or decreased to a specific rotor position, a rotor position prior to the rotor position in which the deviation arose, so as to achieve a uniform or more uniform rotation, this representing the eleventh method step 19. This method step is repeated during each rotation of the electric motor until the deviation lies within the predefined limits. The thirteenth method step 21 terminates the method.

The different features of the individual exemplary embodiments may also be combined with one another.

The exemplary embodiments in FIGS. 1 and 2 are in particular not of a limiting nature and serve to highlight the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A method for operating a fluid conveying device, the fluid conveying device having an electric motor operatively connected and configured to drive a pump stage, the method comprising:
rotating-speed-dependent controlling of the electric motor when an actual speed of the electric motor corresponds to at least one threshold value; and
step-by-step operation of the electric motor when the actual speed of the electric motor corresponds to a value below the at least one threshold value.

17. The method as claimed in claim 16, wherein a revolution of the electric motor is subdivided into individual steps.

18. The method as claimed in claim 17, further comprising counting the individual steps.

19. The method as claimed in claim 18,
wherein the counting the individual steps takes place during the rotating-speed-dependent controlling of the electric motor, or
wherein the counting the individual steps takes place during the step-by-step operation, or wherein the counting the individual steps takes place during the rotating-speed-dependent controlling of the electric motor and during the step-by-step operation of the electric motor.

20. The method as claimed in claim 16,
wherein a nominal speed of the electric motor is determined by a nominal pressure and/or a nominal conveying volume of the fluid conveying device, and/or
wherein a nominal step count of the electric motor is determined by a nominal pressure and/or a nominal conveying volume of the fluid conveying device.

21. The method as claimed in claim 20, wherein the step-by-step operation is a closed-loop control of the electric motor.

22. The method as claimed in claim 21,
wherein the rotating-speed-dependent controlling of the electric motor comprises positively or negatively accelerating the electric motor until the actual speed of the electric motor corresponds to the nominal speed of the electric motor, and/or
wherein the step-by-step operation or the closed-loop control of the electric motor comprises a number of steps after which the electric motor assumes a terminal nominal position and/or has reached a nominal step count.

23. The method as claimed in claim 18, wherein the electric motor is stopped when no fluid conveying is required.

24. The method as claimed in claim 23, wherein a position of the stopped electric motor is maintained until fluid conveying is required and the electric motor as a result thereof reassumes operation.

25. The method as claimed in claim 23, wherein the counting the individual steps continues beyond the stoppage of the electric motor.

26. The method as claimed in claim 21, wherein the method during the step-by-step operation or the closed-loop control further comprises an error compensation comprising:
determining a positional difference between an actual position and a nominal position of the electric motor during a revolution of the electric motor; and
adapting a control current as a function of the determined positional difference.

27. The method as claimed in claim 26, wherein a position of the electric motor in relation to each positional difference is detected and the adapted control current is used as a function of this position.

28. A fluid conveying device comprising:
a pump stage;
an electric motor connected to and configured to drive the pump stage;
at least one position sensor; and
a control unit configured to operate the electric motor configured for:
rotating-speed-dependent controlling of the electric motor when an actual speed of the electric motor corresponds to at least one threshold value; and
step-by-step operation of the electric motor when the actual speed of the electric motor corresponds to a value below the at least one threshold value.

29. A computer program stored on a nontransitory computer readable medium comprising commands that cause a fluid conveying device having a pump stage, an electric motor connected to and configured to drive the pump stage, at least one position sensor; and a control unit configured to operate the electric motor, the commands comprising:
rotating-speed-dependent controlling of the electric motor when an actual speed of the electric motor corresponds to at least one threshold value; and
step-by-step operation of the electric motor when the actual speed of the electric motor corresponds to a value below the at least one threshold value.

30. The method as claimed in claim 16, wherein a revolution of the electric motor is subdivided into at least two steps.
